(19) United States
(12) Patent Application Publication
(10) Pub. No.: US 2016/0160996 A1
(43) Pub. Date: Jun. 9, 2016

(54) SPINDLE DRIVE

(71) Applicant: ROBERT BOSCH GMBH, Stuttgart (DE)

(72) Inventors: Stephan Kohler, Buehl (DE); Andre Johanning, Oetigheim (DE)

(21) Appl. No.: 14/905,939

(22) PCT Filed: Jul. 15, 2014
(86) PCT No.: PCT/EP2014/065090

§ 371 Date: Jan. 18, 2016

(30) Foreign Application Priority Data
Jul. 18, 2013 (DE) 10 2013 214 093.2

(51) Int. Cl. F16H 57/04; F16H 25/20

(52) U.S. Cl. CPC F16H 57/0497; F16H 25/20

(57) ABSTRACT

The invention relates to a spindle drive for converting between a rotational motion and a translational motion comprising a spindle for translational motion and a spindle nut for rotational motion, wherein the spindle and the spindle nut are coupled to each other by means of threads. The spindle nut comprises a reservoir in axial extension of the thread of the spindle nut, in which reservoir a segment of the spindle extends. A lubricant is accommodated in the reservoir, and a displacement element is attached to the spindle in the region of the reservoir, which displacement element extends further outward radially than the thread of the spindle.

### BACKGROUND OF THE INVENTION

The invention relates to a spindle drive. The invention particularly relates to a spindle drive on an actuator for use in a motor vehicle.

A spindle drive comprises a spindle and a spindle nut which are mounted coaxially to a common axis of rotation. The spindle nut has an internal thread and the spindle an external thread, wherein the two threads mesh with one another. If spindle nut and spindle are rotated in opposite directions about the axis of rotation, a translational movement thus occurs between the spindle and the spindle nut along the axis of rotation. In one embodiment, the spindle nut is configured to be set into rotation about the axis of rotation in order to move the spindle along said axis of rotation.

The spindle drive can, for example, be used in an electrohydraulic actuator for use on board of a motor vehicle. In so doing, the spindle can act axially on a hydraulic piston which is accommodated in a hydraulic cylinder. An electric motor can be provided to set the spindle nut into rotation. The rotation of the electric motor is converted by the spindle drive into a translational movement and by the piston into a volume flow or a pressure change of a hydraulic fluid in the cylinder. In this way, a braking or coupling device can be actuated by means of the electric motor.

The German patent publication DE 10 2011 108 962 A1 depicts an electrically driven spindle drive.

The German patent publication DE 10 2009 005 886 A1 depicts a further spindle drive comprising a lubrication channel in order to apply a lubricant to the threads on the spindle and the spindle nut if the spindle is in a predefined parking position in relation to the spindle nut.

The spindle drive can be particularly sensitive to a lack of lubricant in the region where the threads engage with one another. If a lubricant film breaks down in the region of the threads so that segments of the thread are dry when meshing with each other, one or both threads can be subject to a great deal of wear. An abrasion of the thread flanks can exert the effect of an abrasive medium on further thread flanks so that these too wear at an accelerated pace. In an extreme case, the spindle can break, axially slip on the spindle nut or spindle and spindle nut can seize to one another so that a further relative movement is not possible. Such damage occurs especially at high mechanical loads, high numbers of cycles or high ambient temperatures as they can occur in the region of actuators in motor vehicles.

### SUMMARY OF THE INVENTION

It is the aim of the present invention to specify a spindle drive which has an improved load-bearing capacity and is designed as simply as possible.

A spindle drive according to the invention for converting between a rotational motion and a translational motion comprises a spindle for translational motion and a spindle nut for rotational motion, wherein the spindle and the spindle nut are coupled to each other by means of threads. The spindle nut comprises a reservoir in axial extension of the thread thereof, in which reservoir a segment of the spindle extends. A lubricant is accommodated in the reservoir, and a displacement element is attached to the spindle in the region of the reservoir, which displacement element extends further outward radially than the thread of the spindle.

The displacement element moves together with the spindle in the axial direction if the spindle nut is rotated with respect to the spindle. As a result, the lubricant in the reservoir is circulated from the one axial side of the displacement element to the other. As a result of this circulation, lubricant can be applied in an improved manner to the thread of the spindle; thus enabling the lubricant to be distributed along the space between the threads of the spindle nut and the spindle when the spindle repeatedly moves axially. A dry operation of the spindle drive can thereby be prevented. By circulating the lubricant, it can be prevented from clumping together; thus enabling a larger proportion of said lubricant to participate in the lubrication of the two threads. In addition, a separation of different components of the lubricant, for example a base oil and a thickener, can be prevented by the circulation of said lubricant. A spindle drive having a higher load-bearing capacity and improved reliability can be provided by means of the improved lubrication.

In a preferred manner, the reservoir extends axially at least as far as the spindle can move axially. It is especially preferred if the two axial measurements approximately correspond to one another. In this way, an optimal circulation or mixing of the lubrication in the reservoir can be achieved. In the case of a spindle drive having a known power stroke or maximum stroke, for example in order to actuate a clutch, the axial mobility of the spindle and the axial extension of the reservoir can be exactly adapted to one another.

In one embodiment of the invention, the spindle extends into the reservoir on one side only. In a preferred embodiment, the spindle, in contrast, completely passes through the reservoir. In an advantageous manner, the change in the volume of the spindle accommodated in the reservoir over the stroke of the spindle varies less dramatically or not at all. A mechanical resistance can be reduced by the work required for displacement being reduced.

In one embodiment of the invention, the reservoir is rotationally symmetrical. As a result, lubricant can be prevented from accumulating in a radial pocket, where said lubricant is not circulated. It is particularly preferred that the reservoir has a cylindrical shape. An annular clearance between the radial boundary of the reservoir and the rotational body of the displacement element can provide for a uniform circulation of the lubricant in the reservoir.

The displacement element can be connected to the spindle in a rotationally fixed manner. In so doing, a rotatory movement can also be impressed upon the lubricant, which can contribute to an improved circulation thereof.

The displacement element can be rotationally symmetrical. The displacement element can especially comprise a plastic disk which is injection molded around the spindle or is pressed onto said spindle. The radial clearance between the displacement element and the boundary of the reservoir can thereby be especially precisely maintained. A clump of lubricant which is larger than the clearance distance can thereby be reliably prevented from axially crossing the displacement element. The clump can instead be sheared in the clearance.

In a further embodiment of the invention, the displacement element comprises a disk that is open to one side, wherein the spindle has a radial groove for mounting the disk. Such a disk is known in the form of a retaining ring or lock washer. The assembly of the parts of the spindle drive can be facilitated by the radial mounting thereof.

The lubricant preferably comprises a grease with a low viscosity. In particular, the lubricant can comprise a high temperature grease. In addition, a dry lubricant such as graphite or molybdenum disulfide can be mixed into the lubricant.

In still a further embodiment of the invention, a ventilation opening for connecting the reservoir to an ambient environment is provided. The change in the remaining volume in the reservoir, if the spindle is moved axially in relation to the spindle nut, can thus be compensated in an improved manner.

### BRIEF DESCRIPTION OF THE DRAWINGS

The invention is now explained in greater detail with reference to the attached drawings, in which:

FIG. 1 shows a spindle drive in a first view:

FIG. 2 shows the spindle drive from FIG. 1 in a second view; and

FIGS. 3A, 3B and 3C show displacement elements for the spindle drive from one of the FIG. 1 or 2.

### DETAILED DESCRIPTION

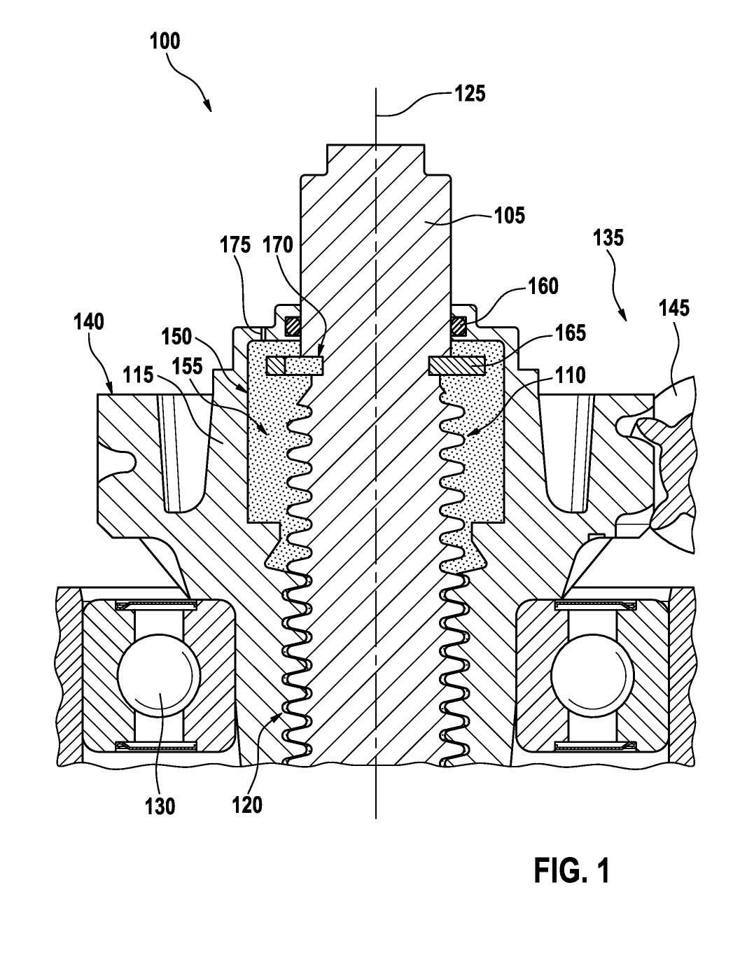

FIG. 1 shows a spindle drive 100, in particular for use on board of a motor vehicle. The spindle drive 100 can, for example, be provided to axially actuate a hydraulic piston in a hydraulic cylinder. The spindle drive 100 comprises a spindle 105 having an exterior thread 110 and a spindle nut 115 having an interior thread 120, wherein the threads 110 and 120 mesh with each other and are disposed coaxially to an axis of rotation 125. In a purely exemplary manner, the spindle nut 115 depicted is mounted by means of a radial bearing 130 in the radial direction. Another bearing can also be used which is equipped to receive axial or tilting forces. In an exemplary manner, the spindle nut 115 is connected by means of a worm gear 135 to an electric motor (not depicted). The worm gear 135 comprises a worm wheel 140, which is integrally embodied here with the spindle nut 115 and is configured coaxially to the axis of rotation 125, and a worm 145 which meshes with the worm wheel 140 and is designed to be fastened to a shaft of the electric motor. Instead of the worm gear 135, another apparatus for transmitting force to the spindle nut 115 can also be provided.

A reservoir 150 that is equipped to accommodate a lubricant 155 is configured on the spindle nut 115. The reservoir 150 is located in the axial extension of the internal thread 120 of the spindle nut 115. In so doing, the reservoir 150 is preferably designed rotationally symmetrical, in particular circularly cylindrical, in relation to the axis of rotation 125.

The spindle 105 is equipped to pass through a maximum axial deflection path along the axis of rotation 125. A segment of the spindle 105 always lies in the reservoir 150 independently of the position of the spindle 105 on the deflection path thereof. As a result, the spindle 105 can extend with an axial end more or less deeply into the reservoir 150 or, as is shown in the embodiment depicted, can completely pass through the reservoir 150. A sealing element 160 is preferably provided in order to seal the reservoir 150 at a first axial end with respect to the spindle 105. The segments of the external thread 110 of the spindle and the internal thread 120 of the spindle nut 115 which mesh with each other are located at the other axial end of the reservoir 150.

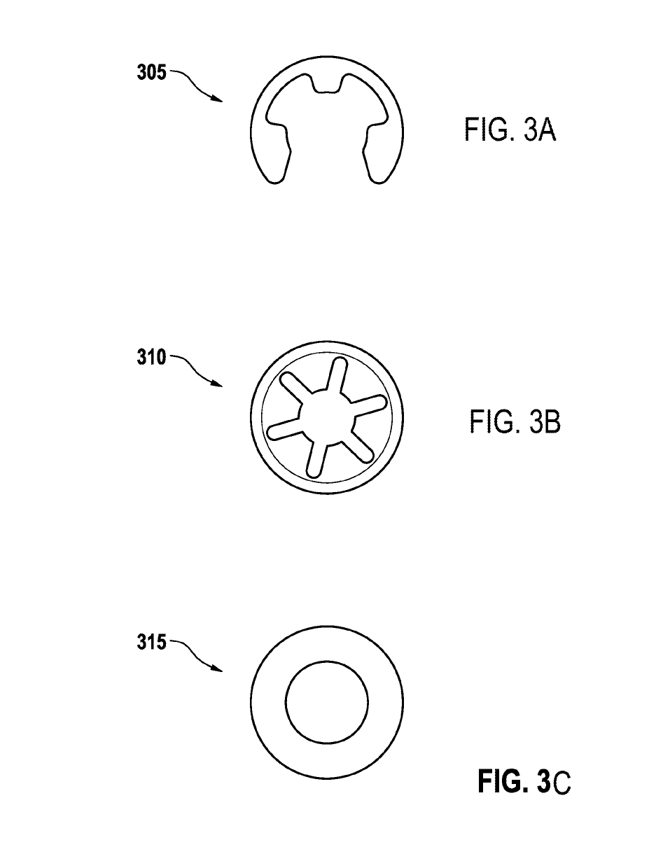

A displacement element 165 is attached to the spindle 105 in the region of the reservoir 150. The displacement element 165 extends further in the radial direction than the external thread 110 of the spindle 105 and can have various shapes, as is described below in more detail in reference to FIG. 3. The displacement element 165 is attached axially to the spindle 105; thus enabling said displacement element 165 to move axially through the reservoir 150 if the spindle 105 is moved axially with respect to the spindle nut 115. Said displacement element 165 circulates the lubricant 155 in the reservoir 150 such that lubricant 155 is better applied to the external thread 110 of the spindle 105. The rotational movement of the internal thread 120 of the spindle nut 115 can then carry the lubricant 155 further in the axial direction and thus ensure a lubricant film between the internal thread 120 and the external thread 110 along the entire region of engagement.

The displacement element 165 can be fixedly or loosely secured on the spindle 105 in the circumferential direction. A groove 170 can be introduced into the spindle 105 in order to axially fix the displacement element 165. In a preferred manner, this relates to a radial annular groove. In one embodiment, a ventilation opening 175 for the pressure equalization of the reservoir with the surrounding environment is provided if, for example, a proportion of the lubricant 155 leaves the reservoir.

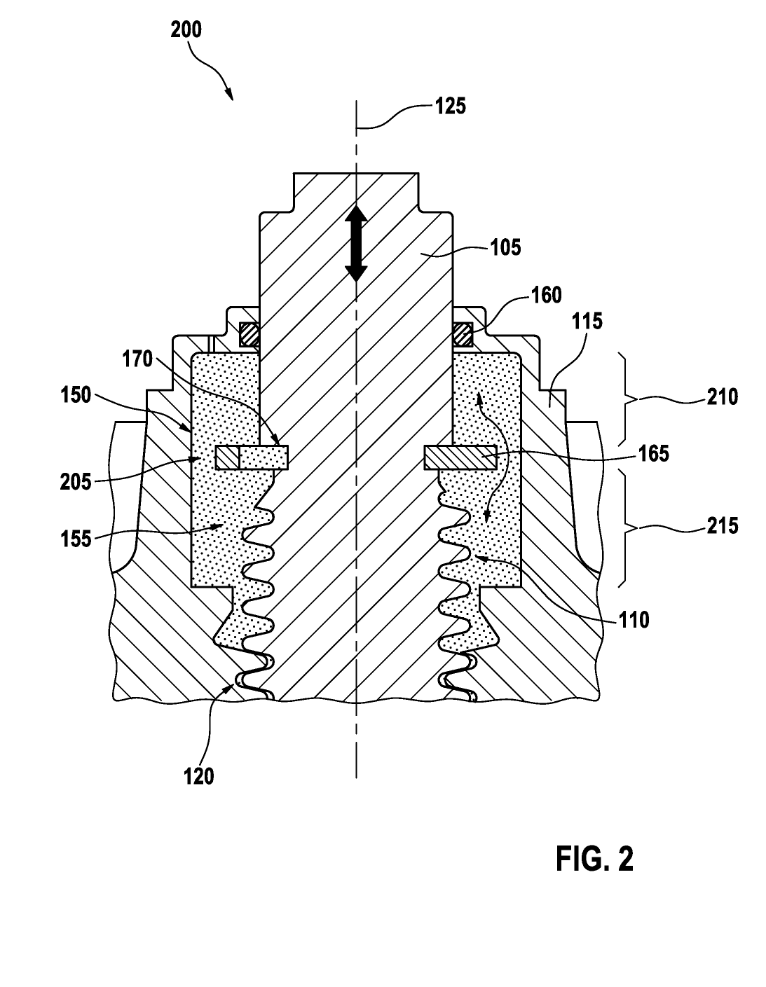

FIG. 2 shows the spindle drive form FIG. 1 in a second view in a further embodiment. The region of the reservoir 150 is presented here enlarged. The displacement element 165 forms an annular clearance 205 with a radial boundary of the reservoir 150. The displacement element 165 and the annular clearance 205 divide the reservoir 150 into a first axial section 210, depicted on top in FIG. 2, and a second axial section 215, depicted on the bottom in FIG. 2. If the displacement element 165 is moved together with the spindle 105 in the axial direction, the volume of the one axial section is enlarged and that of the other is reduced. The lubricant 155 fills up the reservoir 150 as far as possible preferably at least immediately after the filling operation. The changing volumes of the sections 210 and 215 force the lubricant to pass through the annular clearance 205. The lubricant 155 is thereby circulated and mixed in the reservoir 150. The lubricant 155 can thereby wet the external thread 110 of the spindle 105 in an improved manner and penetrate into the region between the external thread 110 and the internal thread 120 of the spindle nut 115. The threads 110 and 115 can thus be better provided with lubricant 155, whereby the service life, the load-bearing capacity or the reliability of the spindle drive 100 can be increased.

The displacement element 165 can be implemented on the spindle in various ways. FIGS. 3A, 3B and 3C show exemplary displacement elements for the spindle drive 100 from FIGS. 1 and 2. From top to bottom, a first displacement element 305, a second displacement element 310 and a third displacement element 315 are depicted.

The first displacement element 305 shown in FIG. 3A is equipped to be axially mounted on the spindle 105. The first displacement element 305 depicted is implemented in the form of a shaft circlip, which is also known as a lock washer. Another design of an external circlip can also be used. As a result, the first displacement element 305 can rotate in the groove 170 of the spindle 105.

The second displacement element 310 shown in FIG. 3B is intended to be axially mounted on the spindle 105. Spring tabs which face radially inwards facilitate a mounting of said second displacement element 310 and hold the second mounting element 310 in the groove 170 in the axial direction.

The third displacement element 315 shown in FIG. 3C has the form of a thrust or flat washer. Said displacement element can, for example, be attached to the spindle 105 in a materially bonded manner, for example by soldering or welding. It is also possible to configure the spindle 105 such that the third displacement element 315 is axially pressed in the groove 170 in order to attach it. In still a further embodiment, the third displacement element 315 is, for example, injection molded from plastic on the spindle 105. The spindle 105 can likewise be manufactured from plastic or, for example, from steel.

Further possible variants of the displacement element 165 become apparent to the person skilled in the art immediately upon observing FIGS. 1 to 3 and the embodiments described above with regard to purpose and properties of the displacement element 165.

1. A spindle drive (100) for converting between a rotational motion and a translational motion, comprising:
a spindle (105);
a spindle nut (115);
wherein the spindle (105) and the spindle nut (115) are coupled to each other by a thread (110) of the spindle and a thread (120) of the spindle nut,
wherein the spindle nut (115) comprises a reservoir (150) in axial extension of the thread (120) of said spindle nut, in which reservoir a segment of the spindle (105) extends,
wherein a lubricant (155) is accommodated in the reservoir (150), characterized by
a displacement element (165) attached to the spindle (105) in a region of the reservoir (150), which displacement element extends further outward radially than the thread (110) of the spindle (105).

2. The spindle drive (100) according to claim 1, wherein the reservoir (150) extends axially at least as far as the spindle (105) can move axially.

3. The spindle drive (100) according to claim 1, wherein the spindle (105) completely passes through the reservoir (150).

4. The spindle drive (100) according to claim 1, wherein the reservoir (150) is rotationally symmetrical.

5. The spindle drive (100) according to claim 1, wherein the displacement element (165) is connected to the spindle (105) in a rotationally fixed manner.

6. The spindle drive (100) according to claim 1, wherein the displacement element (165) is rotationally symmetrical.

7. The spindle drive (100) according to claim 1, wherein the displacement element (165) comprises a plastic disk (315), which is injection molded around the spindle (105).

8. The spindle drive (100) according to claim 1, wherein the displacement element (165) comprises a disk (305) that is open to one side, and the spindle (105) has a radial groove (170) for mounting the disk (305).

9. The spindle drive (100) according to claim 1, wherein the lubricant (155) comprises a grease with low viscosity.

10. The spindle drive (100) according to claim 1, wherein a ventilation opening (175) is configured to connect the reservoir (150) to a surrounding environment.

11. The spindle drive (100) according to claim 1, wherein the displacement element (165) comprises a plastic disk (315), which is pressed onto said spindle.
